(19) United States
(12) Patent Application Publication
(10) Pub. No.: US 2026/0196062 A1
(43) Pub. Date: Jul. 9, 2026

(54) TARGET RECOGNITION DEVICE, TARGET RECOGNITION METHOD, AND NON-TRANSITORY RECORDING MEDIUM

(71) Applicant: TOYOTA JIDOSHA KABUSHIKI KAISHA, Toyota-shi Aichi-ken (JP)

(72) Inventor: Kojiro Tateishi, Kita-ku Tokyo-to (JP)

(73) Assignee: TOYOTA JIDOSHA KABUSHIKI KAISHA, Toyota-shi Aichi-ken (JP)

(21) Appl. No.: 19/440,775

(22) Filed: Jan. 6, 2026

(30) Foreign Application Priority Data
Jan. 9, 2025 (JP) 2025-003611

(51) Int. Cl. G06V 20/56; G06T 7/536; G06V 10/26

(52) U.S. Cl. CPC G06V 20/588; G06T 7/536; G06V 10/26; G06T 2207/30256

(57) ABSTRACT

A target recognition device acquires an image including a line shaped target on a road on which a host vehicle travels and captured by a camera, detects a point cloud showing the target included in the image, generates a plurality of divided areas by dividing an area which includes the point cloud and is included in the image, calculates a vanishing point of the target included in each of the plurality of divided areas based on the point cloud included in each of the plurality of divided areas, and performs a conversion from an image coordinate system to a vehicle coordinate system. The conversion of the point cloud included in each of the plurality of divided areas from the image coordinate system to the vehicle coordinate system is performed by using the vanishing point of the target included in each of the plurality of divided areas.

### CROSS-REFERENCE TO RELATED APPLICATIONS

This application claims priority to Japanese Patent Application No. 2025-003611

filed Jan. 9, 2025, the entire contents of which are herein incorporated by reference.

### FIELD

The present disclosure relates to target recognition device, target recognition method, and non-transitory recording medium.

### BACKGROUND

PTL 1 (JP-A-2001-076147) discloses that a white line feature point extraction means extracts a sequence of points on an image of left and right white lines from a road image as a white line feature point sequence, divides the road image into upper region and lower region, and determines a first vanishing point which is an intersection point of a left first straight line (straight line approximating a white line to the left of a host vehicle) and a right first straight line (straight line approximating a white line to the right of the host vehicle), the left first straight line and the right first straight line being included in the lower region detected by the white line feature point extraction means.

In the technique described in PTL 1, left and right white line approximation straight lines in the upper region are detected from a horizontal line passing through the first vanishing point, the left and right first straight lines, and the white line feature point sequence of the upper region extracted by the white line feature point extraction means. However, PTL 1 does not disclose a coordinate conversion which is necessary to obtain specific shape (shape in a vehicle coordinate system) of the white line to the left of the host vehicle and the white line to the right of the host vehicle.

In the conventional general coordinate conversion, although the coordinate conversion from an image coordinate point to a vehicle coordinate point is performed, in order to improve the accuracy of the shape of a target (e.g., white line (partition line), etc.) after coordinate conversion, it is not performed to use a virtual point (e.g., vanishing point, etc.) which is not actually included in the image for the coordinate conversion. Therefore, conventionally, it is impossible to sufficiently improve the accuracy of the shape of the target after the conversion from an image coordinate system to the vehicle coordinate system.

### SUMMARY

In view of the above-described points, it is an object of the present disclosure to provide that can improve the accuracy of the shape of the target after the conversion from the image coordinate system to the vehicle coordinate system.

(1) One aspect of the present disclosure is a target recognition device including a processor configured to: acquire an image which includes a line shaped target on a road on which a host vehicle travels, and which is captured by a camera; detect a point cloud showing the target included in the image; generate a plurality of divided areas by dividing an area which includes the point cloud and is included in the image; calculate a vanishing point of the target included in each of the plurality of divided areas based on the point cloud included in each of the plurality of divided areas; and perform a conversion from an image coordinate system to a vehicle coordinate system, wherein the processor is configured to perform the conversion of the point cloud included in each of the plurality of divided areas from the image coordinate system to the vehicle coordinate system, by using the vanishing point of the target included in each of the plurality of divided areas.

(2) In the target recognition device of the aspect (1), the processor may be configured to estimate a static posture of the camera based on calibration result or traveling learning result, the processor may be configured to perform the conversion of the point cloud included in each of the plurality of divided areas from the image coordinate system to the vehicle coordinate system, by using a horizontal coordinate of the vanishing point on the image which is calculated from the static posture of the camera, and a vertical coordinate of the vanishing point of the target included in each of the plurality of divided areas on the image.

(3) In the target recognition device of the aspect (1) or (2), the processor may be configured to acquire a longitudinal gradient change amount of the road on which the host vehicle travels, the processor may be configured to determine the number of the plurality of divided areas or division position of the area including the point cloud, based on the longitudinal gradient change amount.

(4) Another aspect of the present disclosure is a target recognition method including: acquiring an image which includes a line shaped target on a road on which a host vehicle travels, and which is captured by a camera; detecting a point cloud showing the target included in the image; generating a plurality of divided areas by dividing an area which includes the point cloud and is included in the image; calculating a vanishing point of the target included in each of the plurality of divided areas based on the point cloud included in each of the plurality of divided areas; and performing a conversion from an image coordinate system to a vehicle coordinate system, wherein the conversion of the point cloud included in each of the plurality of divided areas from the image coordinate system to the vehicle coordinate system is performed by using the vanishing point of the target included in each of the plurality of divided areas.

(5) Another aspect of the present disclosure is a non-transitory recording medium having recorded thereon a computer program for causing a processor to perform a process including: acquiring an image which includes a line shaped target on a road on which a host vehicle travels, and which is captured by a camera; detecting a point cloud showing the target included in the image; generating a plurality of divided areas by dividing an area which includes the point cloud and is included in the image; calculating a vanishing point of the target included in each of the plurality of divided areas based on the point cloud included in each of the plurality of divided areas; and performing a conversion from an image coordinate system to a vehicle coordinate system, wherein the conversion of the point cloud included in each of the plurality of divided areas from the image coordinate system to the vehicle coordinate system is performed by using the vanishing point of the target included in each of the plurality of divided areas.

According to the present disclosure, it is possible to improve the accuracy of the shape of the target after the conversion from the image coordinate system to the vehicle coordinate system.

### BRIEF DESCRIPTION OF DRAWINGS

FIG. 1 is a view showing an example of a host vehicle 1 to which a target recognition device 12 of a first embodiment is applied.

FIG. 2A is a view showing an example of an image IM including line shaped targets TG1, TG2 (partition lines) on an uphill road RD (in detail, road RD with increasing gradient) captured by a camera 11A when the host vehicle 1 is traveling on the road RD.

FIG. 2B is a view showing an example of an image IM including the line shaped targets TG1, TG2 (partition lines) on a road RD1 on which the host vehicle 1 is traveling, a sidewall SW of the road RD1, the line shaped targets TG3, TG4 (partition lines) on a road RD2 corresponding a main lane of an expressway, and the sidewall SW of the road RD2, which are captured by the camera 11A immediately after the host vehicle 1 branches off from the road RD2 corresponding to the main lane of the expressway.

FIG. 3A is a view showing two divided areas IM11, IM12 generated by an area division unit 3C and a vanishing point FOE1 of the targets TG1, TG2 included in the divided area IM11 calculated by a vanishing point calculation unit 3D based on point clouds TG11, TG21 included in the divided area IM11.

FIG. 3B is a view showing a state after the point clouds TG11, TG21 included in the divided area IM11 shown in FIG. 3A is converted from an image coordinate system to a vehicle coordinate system by a coordinate conversion unit 3E, by using the vanishing point FOE1 of the targets TG1, TG2 included in the divided area IM11 calculated by the vanishing point calculation unit 3D.

FIG. 3C is a view showing the two divided areas IM11, IM12 generated by the area division unit 3C and the vanishing point FOE2 of the targets TG1, TG2 included in the divided area IM12 calculated by the vanishing point calculation unit 3D based on the point clouds TG11, TG21 included in the divided area IM12.

FIG. 3D is a view showing the state after the point clouds TG11, TG21 included in the divided area IM12 shown in FIG. 3C is converted from the image coordinate system to the vehicle coordinate system by the coordinate conversion unit 3E, by using the vanishing point FOE2 of the targets TG1, TG2 included in the divided area IM12 calculated by the vanishing point calculation unit 3D.

FIG. 4A is a view showing a camera mounting yaw angle θ.

FIG. 4B is a view showing a plane including the image IM (refer to FIG. 2A and the like) captured by the camera 11A as seen from above the host vehicle 1.

FIG. 5A is a view showing an example in which a longitudinal gradient change amount is large.

FIG. 5B is a view showing an example in which the longitudinal gradient change amount is small.

FIG. 6A is a view showing an example in which the two divided areas IM11, IM12 are generated by the area division unit 3C.

FIG. 6B is a view showing a comparative example in which a plurality of divided areas is not generated (i.e., comparative example in which an area IM1 is not divided).

FIG. 7A is a view showing an example in which the area IM1 is not divided by the area division unit 3C.

FIG. 7B is a view showing a difference between an actual road surface and a virtual road surface in the example in which the area IM1 is not divided by the area division unit 3C.

FIG. 7C is a view showing an example in which the area IM1 is divided into the divided areas IM11, IM12 by the area division unit 3C.

FIG. 7D is a view showing a difference between the actual road surface and a virtual road surface of the divided area IM11 (first virtual road surface) and a difference between the actual road surface and a virtual road surface of the divided area IM12 (second virtual road surface) in the example in which the area IM1 is divided into the divided areas IM11, IM12 by the area division unit 3C.

FIG. 8 is a view for explaining the height H3 in the vehicle coordinate system of the road RD on which the host vehicle 1 travels, and the like.

FIG. 9A is a view showing a process in which a target position estimation unit 3J estimates positions of the targets TG1, TG2 on a boundary between the divided area IM11 and the divided area IM12.

FIG. 9B is a view showing a process in which the vanishing point calculation unit 3D calculates the vanishing point FOE1 of the targets TG1, TG2 included in the divided area IM11 by using the positions of the targets TG1, TG2 on the boundary between the divided area IM11 and the divided area IM12 estimated by the target position estimation unit 3J.

FIG. 9C is a view showing a process in which the vanishing point calculation unit 3D calculates the vanishing point FOE2 of the targets TG1, TG2 included in the divided area IM12 by using the positions of the targets TG1, TG2 on the boundary between the divided area IM11 and the divided area IM12 estimated by the target position estimation unit 3J.

FIG. 10 is a flowchart for explaining an example of a process performed by a processor 123 of the target recognition device 12 of the first embodiment.

### DESCRIPTION OF EMBODIMENTS

Below, referring to the drawings, embodiments of target recognition device, target recognition method, and non-transitory recording medium of the present disclosure will be explained.

### First Embodiment

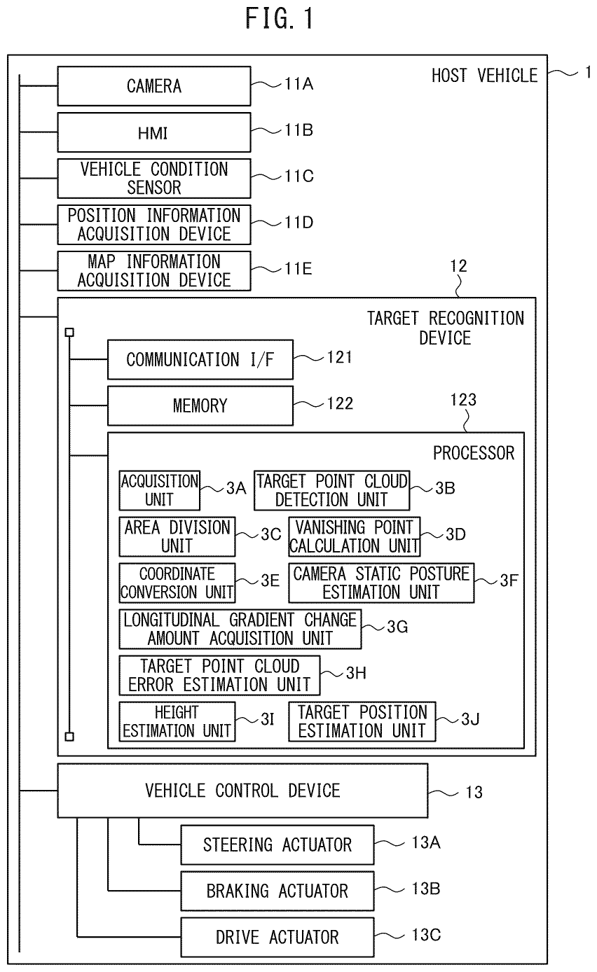

FIG. 1 is a view showing an example of a host vehicle 1 to which a target recognition device 12 of a first embodiment is applied.

In the example shown in FIG. 1, the host vehicle 1 includes camera 11A, HMI (Human Machine Interface) 11B, vehicle condition sensor 11C, position information acquisition device 11D, map information acquisition device 11E, target recognition device 12, vehicle control device 13, steering actuator 13A, braking actuator 13B, and drive actuator 13C.

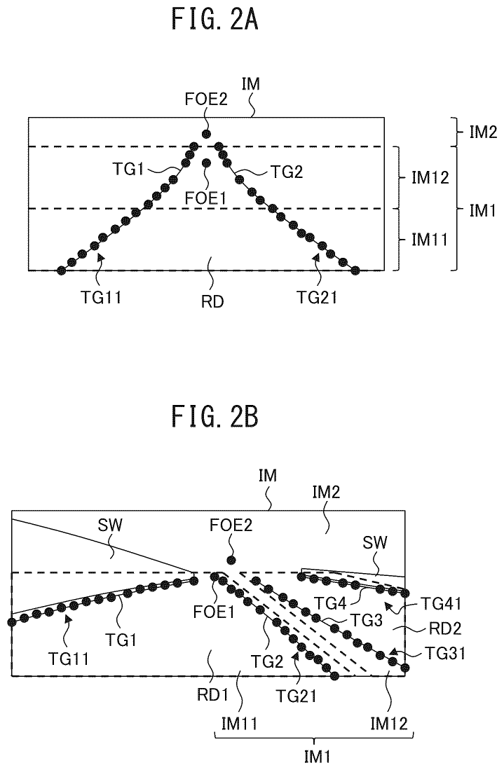

The camera 11A captures an image IM (see FIG. 2A and FIG. 2B) including line shaped targets TG1 to TG4 (see FIG. 2A and FIG. 2B) (for example, partition line, guardrail, median strip, curb, side wall of highway, or the like) such as on a road RD, RD1 on which the host vehicle 1 travels, and transmits data of the image IM to the target recognition device 12, the vehicle control device 13, and the like.

The HMI 11B has function of receiving various operations of a driver of the host vehicle 1, function of presenting various types of information such as, for example, lane departure alert and the like to the driver of the host vehicle 1, and the like, and transmits signals indicating the operations of the driver of the host vehicle 1 to the vehicle control device 13 and the like.

The vehicle condition sensor 11C detects the condition of the host vehicle 1 and transmits the detection result to the target recognition device 12, the vehicle control device 13, and the like. The vehicle condition sensor 11C includes, for example, vehicle speed sensor, acceleration sensor, sensor used for calibration or traveling learning of the target recognition device 12.

The position information acquisition device 11D acquires information indicating the position of the host vehicle 1. The position information acquisition device 11D includes, for example, GPS (Global Positioning System) device which measure the position of the host vehicle 1 or the like. The position information acquisition device 11D transmits the information indicating the position of the host vehicle 1 to the target recognition device 12, the vehicle control device 13, and the like.

The map information acquisition device 11E acquires map information from the map database and transmits the map information to the target recognition device 12, the vehicle control device 13, and the like.

The target recognition device 12 recognizes the line shaped targets TG1 to TG4 (see FIG. 2A and FIG. 2B) on the road RD, RD1 on which the host vehicle 1 travels or the like, the line shaped targets TG1 to TG4 being included in the image IM captured by the camera 11A. The target recognition device 12 transmits recognition result of the targets TG1 to TG4 to the vehicle control device 13 and the like.

The vehicle control device 13 controls the steering actuator 13A, the braking actuator 13B, and the drive actuator 13C based on the information (signals, data) transmitted from the camera 11A, the HMI 11B, the target recognition device 12, and the like.

FIG. 2A and FIG. 2B are views showing examples of images IM including the targets TG1 to TG4 (partition lines) captured by the camera 11A. In detail, FIG. 2A shows the example of the image IM including the line shaped targets TG1, TG2 (partition lines) on an uphill road RD (in detail, road RD with increasing gradient) captured by the camera 11A when the host vehicle 1 is traveling on the road RD. FIG. 2B shows the example of the image IM including the line shaped targets TG1, TG2 (partition lines) on a road RD1 on which the host vehicle 1 is traveling, a sidewall SW of the road RD1, the line shaped targets TG3, TG4 (partition lines) on a road RD2 corresponding a main lane of an expressway, and the sidewall SW of the road RD2, which are captured by the camera 11A immediately after the host vehicle 1 branches off from the road RD2 corresponding to the main lane of the expressway.

In the examples shown in FIG. 2A and FIG. 2B, the vehicle control device 13 executes autonomous driving (lane trace control) of the host vehicle 1 in which the steering actuator 13A is operated so that the host vehicle 1 does not deviate from a lane (lane in which the host vehicle 1 is traveling) defined by the targets TG1, TG2 (partition lines) recognized by the target recognition device 12.

In another example, the vehicle control device 13 may perform steering assistance in which the steering actuator 13A is operated so that the vehicle 1 does not deviate from the lane (lane in which the vehicle 1 is traveling) defined by the targets TG1, TG2 (partition lines) recognized by the target recognition device 12.

In yet another example, the vehicle control device 13 may cause the HMI 11B to output the lane departure alert so that the vehicle 1 does not deviate from the lane (lane in which the vehicle 1 is traveling) defined by the targets TG1, TG2 (partition lines) recognized by the target recognition device 12.

In an example in which the partition line is not included, but the guardrail, the median strip, the curb, the side wall, or the like is included in the image IM captured by the camera 11A as the line shaped target on the road RD, RD1 on which the host vehicle 1 travels, the vehicle control device 13 executes the autonomous driving of the host vehicle 1 in which the steering actuator 13A, the braking actuator 13B, or the like is operated so that the host vehicle 1 does not collide with the target recognized by the target recognition device 12.

The target recognition device 12 is configured by a microcomputer including communication interface (I/F) 121, memory 122, and processor 123. The communication interface 121 includes an interface circuit for connecting the target recognition device 12 to the camera 11A, the HMI 11B, the vehicle condition sensor 11C, the position information acquisition device 11D, the map information acquisition device 11E, the vehicle control device 13, and the like. The memory 122 stores a program used in a process performed by the processor 123 and various data.

The processor 123 has function as an acquisition unit 3A, function as a target point cloud detection unit 3B, a function as an area division unit 3C, function as a vanishing point calculation unit 3D, function as a coordinate conversion unit 3E, function as a camera static posture estimation unit 3F, function as a longitudinal gradient change amount acquisition unit 3G, function as a target point cloud error estimation unit 3H, function as a height estimation unit 3I, and function as a target position estimation unit 3J.

The acquisition unit 3A acquires the image IM including the line shaped targets TG1 to TG4 on the road RD, RD1 on which the host vehicle 1 travels or the like captured by the camera 11A, and the like.

The target point cloud detection unit 3B detects the point clouds TG11 to TG41 showing the targets TG1 to TG4 included in the image IM acquired by the acquisition unit 3A.

In the example shown in FIG. 2A, the target point cloud detection unit 3B detects the point cloud TG11 showing the target TG1 corresponding to the partition line on the left side of the road RD on which the host vehicle 1 is traveling, and the point cloud TG21 showing the target TG2 corresponding to the partition line on the right side of the road RD, the target TG1 and the target TG2 are included in the image IM.

In the example shown in FIG. 2B, the target point cloud detection unit 3B detects the point cloud TG11 showing the target TG1 corresponding to the partition line on the left side of the road RD1 on which the host vehicle 1 is traveling, the point cloud TG21 showing the target TG2 corresponding to the partition line on the right side of the road RD1, the point cloud TG31 showing the target TG3 corresponding to the partition line on the left side of the road RD2 corresponding the main lane of the expressway, and the point cloud TG41 showing the target TG4 corresponding to the partition line on the right side of the road RD2 corresponding the main lane of the expressway, the target TG1, the target TG2, the target TG3 and the target TG4 are included in the image IM.

In the example shown in FIG. 1, the area division unit 3C generates a plurality of divided areas IM11, IM12 (see FIG. 2A and FIG. 2B) by dividing the area IM1 which includes the point clouds TG11 to TG41 detected by the target point cloud detection unit 3B and is included in the image IM. In FIG. 2A and FIG. 2B, the symbol IM2 shows the area (that is, area other than the area IM1 among the image IM) which does not include the point clouds TG11 to TG41 and is included in the image IM.

In the example shown in FIG. 2A, the area division unit 3C generates two divided areas IM11, IM12 by dividing the area IM1 which includes the point clouds TG11, TG21 and is included in the image IM.

In the example shown in FIG. 2B, the area division unit 3C generates two divided areas IM11, IM12 by dividing the area IM1 which includes the point clouds TG11 to TG41 and is included in the image IM.

In the example shown in FIG. 1, the vanishing point calculation unit 3D calculates the vanishing points FOE1, FOE2 of the targets TG1 to TG4 included in each of the plurality of divided areas IM11, IM12 based on the point clouds TG11 to TG41 included in each of the plurality of divided areas IM11, IM12.

In the example shown in FIG. 2A, the vanishing point calculation unit 3D calculates the vanishing point FOE1 of the targets TG1, TG2 included in the divided area IM11 based on the point clouds TG11, TG21 included in the divided area IM11, and the vanishing point FOE2 of the targets TG1, TG2 included in the divided area IM12 based on the point clouds TG11, TG21 included in the divided area IM12.

In the example shown in FIG. 2B, the vanishing point calculation unit 3D calculates the vanishing point FOE1 of the targets TG1, TG2 included in the divided area IM11 based on the point clouds TG11, TG21 included in the divided area IM11, and the vanishing point FOE2 of the targets TG3, TG4 included in the divided area IM12 based on the point clouds TG31, TG41 included in the divided area IM12.

In the example shown in FIG. 1, the coordinate conversion unit 3E performs a conversion from an image coordinate system as shown, for example, in FIG. 2A and FIG. 2B to a vehicle coordinate system. Specifically, the coordinate conversion unit 3E performs the conversion of the point clouds TG11 to TG41 included in each of the plurality of divided areas IM11, IM12 from the image coordinate system to the vehicle coordinate system, by using the vanishing points FOE1, FOE2 of the targets TG1 to TG4 included in each of the plurality of divided areas IM11, IM12 calculated by the vanishing point calculation unit 3D.

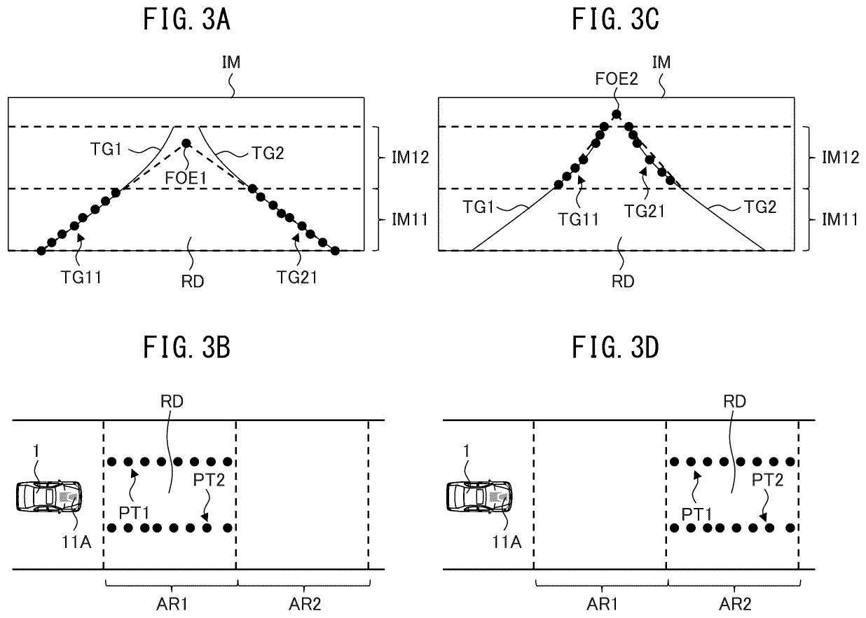

FIG. 3A to FIG. 3D are views for explaining an example of processes to the image IM shown in FIG. 2A by the area division unit 3C, the vanishing point calculation unit 3D, and the coordinate conversion unit 3E. Specifically, FIG. 3A shows the two divided areas IM11, IM12 generated by the area division unit 3C and the vanishing point FOE1 of the targets TG1, TG2 included in the divided area IM11 calculated by the vanishing point calculation unit 3D based on the point clouds TG11, TG21 included in the divided area IM11. FIG. 3B shows a state after the point clouds TG11, TG21 included in the divided area IM11 shown in FIG. 3A is converted from the image coordinate system to the vehicle coordinate system by the coordinate conversion unit 3E, by using the vanishing point FOE1 of the targets TG1, TG2 included in the divided area IM11 calculated by the vanishing point calculation unit 3D. FIG. 3C shows the two divided areas IM11, IM12 generated by the area division unit 3C and the vanishing point FOE2 of the targets TG1, TG2 included the divided area IM12 calculated by the vanishing point calculation unit 3D based on the point clouds TG11, TG21 included in the divided area IM12. FIG. 3D shows the state after the point clouds TG11, TG21 included in the divided area IM12 shown in FIG. 3C is converted from the image coordinate system to the vehicle coordinate system by the coordinate conversion unit 3E, by using the vanishing point FOE2 of the targets TG1, TG2 included in the divided area IM12 calculated by the vanishing point calculation unit 3D.

In the example shown in FIG. 3A to FIG. 3D, the area AR1 of the vehicle coordinate system shown in FIG. 3B and FIG. 3D corresponds to the divided area IM11 of the image coordinate system shown in FIG. 3A and FIG. 3C. Partition line points PT1 (points which constitutes a part of the partition line on the left side of the host vehicle 1) included in the area AR1 of the vehicle coordinate system shown in FIG. 3B corresponds to the point cloud TG11 included in the divided area IM11 of the image coordinate system shown in FIG. 3A. The partition line points PT2 (points which constitutes a part of the partition line on the right side of the host vehicle 1) included in the area AR1 of the vehicle coordinate system shown in FIG. 3B corresponds to the point cloud TG21 included in the divided area IM11 of the image coordinate system shown in FIG. 3A.

The area AR2 of the vehicle coordinate system shown in FIG. 3B and FIG. 3D corresponds to the divided area IM12 of the image coordinate system shown in FIG. 3A and FIG. 3C. The partition line points PT1 included in the area AR2 of the vehicle coordinate system shown in FIG. 3D corresponds to the point cloud TG11 included in the divided area IM12 of the image coordinate system shown in FIG. 3C. The partition line points PT2 included in the area AR2 of the vehicle coordinate system shown in FIG. 3D corresponds to the point cloud TG21 included in the divided area IM12 of the image coordinate system shown in FIG. 3C.

In the example shown in FIG. 3A to FIG. 3D, the vanishing point calculation unit 3D calculates an intersection point of a straight line passing through the point cloud TG11 included in the divided area IM11 (in detail, straight line passing through the point cloud TG11 at the lower end of FIG. 3A and the point cloud TG11 at the upper end of FIG. 3A in the divided area IM11) (in other words, straight line shown by a broken line at the left side of FIG. 3A) and a straight line passing through the point cloud TG21 included in the divided area IM11 (in detail, straight line passing through the point cloud TG21 at the lower end of FIG. 3A and the point cloud TG21 at the upper end of FIG. 3A in the divided area IM11) (in other words, straight line shown by a broken line at the right side of FIG. 3A) as the vanishing point FOE1. Further, the vanishing point calculation unit 3D calculates an intersection point of a straight line passing through the point cloud TG11 included in the divided area IM12 (in detail, straight line passing through the point cloud TG11 at the lower end of FIG. 3C and the point cloud TG11 at the upper end of FIG. 3C in the divided area IM12) (in other words, straight line shown by a broken line at the left side of FIG. 3C) and a straight line passing through the point cloud TG21 included in the divided area IM12 (in detail, straight line passing through the point cloud TG21 at the lower end of FIG. 3C and the point cloud TG21 at the upper end of FIG. 3C in the divided area IM12) (in other words, straight line shown by a broken line at the right side of FIG. 3C) as the vanishing point FOE2.

In the example shown in FIG. 3A to FIG. 3D, the coordinate conversion unit 3E performs the conversion from the point clouds TG11, TG21 included in the divided area IM11 of the image coordinate system shown in FIG. 3A to the partition line points PT1, PT2 included in the area AR1 of the vehicle coordinate system shown in FIG. 3B, by using the vanishing point FOE1 of the targets TG1, TG2 included in the divided area IM11 shown in FIG. 3A. Specifically, the coordinate conversion unit 3E can calculate the partition line points PT1, PT2 included in the area AR1 of the vehicle coordinate system shown in FIG. 3B with higher accuracy by using the vanishing point FOE1 shown in FIG. 3A, than when the vanishing point FOE1 is not used.

In addition, the coordinate conversion unit 3E performs the conversion from the point clouds TG11, TG21 included in the divided area IM12 of the image coordinate system shown in FIG. 3C to the partition line points PT1, PT2 included in the area AR2 of the vehicle coordinate system shown in FIG. 3D, by using the vanishing point FOE2 of the targets TG1, TG2 included in the divided area IM12 shown in FIG. 3C. Specifically, the coordinate conversion unit 3E can calculate the partition line points PT1, PT2 included in the area AR2 of the vehicle coordinate system shown in FIG. 3D with higher accuracy by using the vanishing point FOE2 shown in FIG. 3C, than when the vanishing point FOE2 is not used.

On the other hand, in a comparative example in which the vanishing points FOE1, FOE2 are not used, since the targets TG1, TG2 in the image IM is curved according to the change in the upward gradient of the road RD, point sequences of the curved partition line points PT1, PT2 of the vehicle coordinate system are calculated although the targets TG1, TG2 (partition lines) are line shaped.

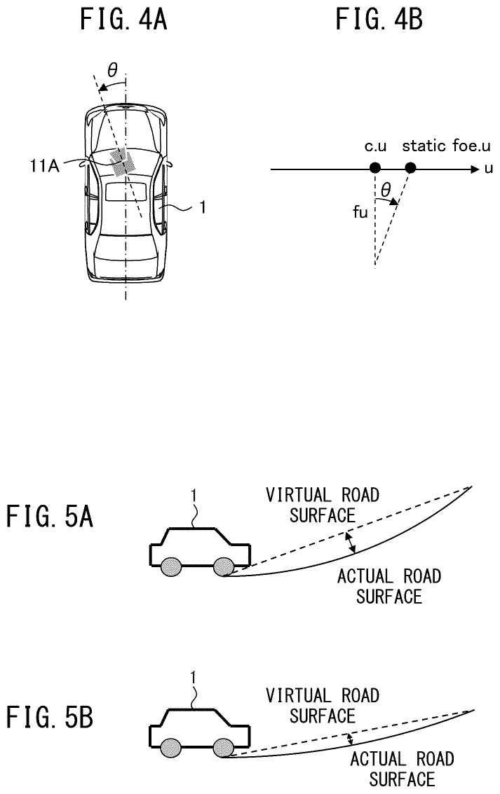

In the example shown in FIG. 1, the camera static posture estimation unit 3F estimates a static posture of the camera 11A (camera mounting yaw angle θ (see FIG. 4A and FIG. 4B)) based on calibration result or traveling learning result.

FIG. 4A and FIG. 4B are views for explaining the static posture of the camera 11A (camera mounting yaw angle θ) which is estimated by the camera static posture estimation unit 3F, and the like. Specifically, FIG. 4A shows the camera mounting yaw angle θ, and FIG. 4B is a view showing a plane including the image IM (refer to FIG. 2A and the like) captured by the camera 11A as seen from above the host vehicle 1. Specifically, the u-axis shown in FIG. 4B corresponds to the plane including the image IM.

The camera static posture estimation unit 3F calculates a horizontal coordinate (u coordinate) static foe. u of the vanishing points FOE1, FOE2 (refer to FIG. 2A, etc.) shown in FIG. 4B based on the camera mounting yaw angle θ shown in FIG. 4A and FIG. 4B, a focal length/pixel width fu of the camera 11A shown in FIG. 4B, a u coordinate (horizontal coordinate) c. u of the center of the image IM shown in FIG. 4B, and an equation shown below.

$$static foe . u = fu \times tan θ + c . u$$

The coordinate conversion unit 3E performs the conversion of the point clouds TG11, TG21 included in each of the plurality of divided areas IM11, IM12 from the image coordinate system to the vehicle coordinate system as shown in FIG. 3A to FIG. 3D, by using the horizontal coordinate (u coordinate) of the vanishing points FOE1, FOE2 and the vertical coordinate (v coordinate) of the vanishing points FOE1, FOE2 calculated by the camera static posture estimation unit 3F. Therefore, even when the camera mounting yaw angle θ is not zero (i.e., when the optical axis of the camera 11A and the front-rear direction of the host vehicle 1 are not parallel), it is possible to calculate the partition line points PT1, PT2 included in the areas AR1, AR2 of the vehicle coordinate system with high accuracy.

In the example shown in FIG. 1, the longitudinal gradient change amount acquisition unit 3G acquires a longitudinal gradient change amount of the road RD, RD1 on which the host vehicle 1 travels. Specifically, the longitudinal gradient change amount acquisition unit 3G acquires the longitudinal gradient change amount of the road RD, RD1 on which the host vehicle 1 travels from the map information acquired by the map information acquisition device 11E.

In another example, the longitudinal gradient change amount acquisition unit 3G may acquire the longitudinal gradient change amount that can be acquired without using the map information, such as the longitudinal gradient change amount detected by a gradient change detection device described in JP-A-2019-95956 or the like.

FIG. 5A and FIG. 5B are views showing an example in which the longitudinal gradient change amount is large and an example in which the longitudinal gradient change amount is small, in comparison. Specifically, FIG. 5A shows the example in which the longitudinal gradient change amount is large, and FIG. 5B shows the example in which the longitudinal gradient change amount is small.

When the longitudinal gradient change amount is large as shown in FIG. 5A, because the difference between the actual road surface and the virtual road surface is large, there is a possibility that the curvature of the targets TG1, TG2 in the image IM is large as shown in FIG. 3A, and the error (with respect to the actual targets (partition lines)) of the partition line points PT1, PT2 (refer to FIG. 3B, etc.) of the vehicle coordinate system calculated by the coordinate conversion unit 3E is large.

On the other hand, when the longitudinal gradient change amount is small as shown in FIG. 5B, because the difference between the actual road surface and the virtual road surface is small, the curvature of the targets TG1, TG2 in the image IM is small, and the error (with respect to the actual targets (partition lines)) of the partition line points PT1, PT2 of the vehicle coordinate system calculated by the coordinate conversion unit 3E is small.

Therefore, in the example shown in FIG. 1, the area division unit 3C determines the number of the plurality of divided areas IM11, IM12 or division position of the area IM1 including the point clouds TG11, TG21, based on the longitudinal gradient change amount acquired by the longitudinal gradient change amount acquisition unit 3G. For example, as the longitudinal gradient change amount increases, the area division unit 3C increases the number of the divided areas IM11, IM12. For example, the area division unit 3C decreases the error of the partition line points PT1, PT2 of the vehicle coordinate system calculated by the coordinate conversion unit 3E, by setting the division position of the area IM1 at a position where the curvature of the targets TG1, TG2 in the image IM is large.

Further, in the example shown in FIG. 1, the target point cloud error estimation unit 3H estimates an error of the point clouds TG11 to TG41 showing the targets TG1 to TG4 detected by the target point cloud detection unit 3B.

In an example of the process performed by the target point cloud error estimation unit 3H, the detection result of the point clouds showing the targets included in a learning image (not shown) by the target point cloud detection unit 3B is compared with a manual detection result (correct answer data) of the point clouds showing the targets included in the learning image (not shown), and the target point cloud error estimation unit 3H estimates the error of the point clouds TG11 to TG41 showing the targets TG1 to TG4 detected by the target point cloud detection unit 3B based on the result of the comparison.

The area division unit 3C determines the number of the plurality of divided areas IM11, IM12 based on the estimation result of the target point cloud error estimation unit 3H.

In an example of the process performed by the area division unit 3C, as differences between detection positions of the point clouds showing the targets included in the learning image (not shown) by the target point cloud detection unit 3B and manual detection positions (correct positions) of the point clouds showing the targets included in the learning image (not shown), horizontal position errors of the point clouds on the learning image are calculated, a standard deviation of the horizontal position errors with zero mean is calculated. The number of the plurality of divided areas generated by the area division unit 3C is set to “2” when the standard deviation is equal to or greater than a threshold. The number of the plurality of divided areas generated by the area division unit 3C is set to “3” when the standard deviation is less than the threshold.

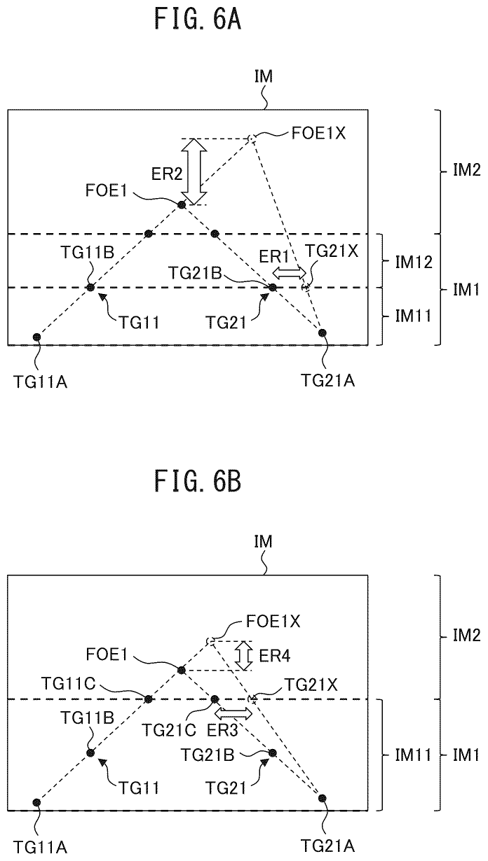

FIG. 6A and FIG. 6B are views showing a relation between the errors of the point clouds TG11, TG21 showing the targets TG1, TG2 detected by the target point cloud detection unit 3B and the vanishing point FOE1 calculated by the vanishing point calculation unit 3D. Specifically, FIG. 6A shows an example in which the two divided areas IM11, IM12 are generated by the area division unit 3C, and FIG. 6B shows a comparative example in which a plurality of divided areas are not generated (that is, comparative example in which the area IM1 is not divided).

In the example shown in FIG. 6A in which the two divided area IM11, IM12 are generated, when the point cloud TG21 detected by the target point cloud detection unit 3B does not include the error ER1, the vanishing point calculation unit 3D calculates the vanishing point FOE1 based on points TG11A, TG11B constituting a part of the point cloud TG11 and points TG21A, TG21B constituting a part of the point cloud TG21.

On the other hand, when the point cloud TG21 detected by the target point cloud detection unit 3B includes the error ER1, the vanishing point calculation unit 3D calculates the vanishing point FOE1X including a longitudinal error ER2 based on the points TG11A, TG11B constituting the part of the point cloud TG11 and the points TG21A, TG21X constituting the part of the point cloud TG21 including the error ER1.

In the comparative example shown in FIG. 6B in which the plurality of divided areas are not generated, when the point cloud TG21 detected by the target point cloud detection unit 3B does not include the error ER3, the vanishing point calculation unit 3D calculates the vanishing point FOE1 based on the points TG11A, TG11C constituting the part of the point cloud TG11 and the points TG21A, TG21C constituting the part of the point cloud TG21.

When the error ER3 is included in the point cloud TG21 detected by the target point cloud detection unit 3B, although the vanishing point FOE1X including the longitudinal error ER4 is calculated by the vanishing point calculation unit 3D, based on the points TG11A, TG11C constituting the part of the point cloud TG11 and the points TG21A, TG21X constituting the part of the point cloud TG21 including the error ER3, the longitudinal error ER4 shown in FIG. 6B is smaller than the longitudinal error ER2 shown in FIG. 6A.

That is, when the point cloud TG21 detected by the target point cloud detection unit 3B includes the errors ER1, ER3, the number of the plurality of divided areas IM11, IM12 generated by the area division unit 3C needs to be reduced in order to reduce the longitudinal errors ER2, ER4 of the vanishing point FOE1X.

Therefore, in the example shown in FIG. 1, as described above, the area division unit 3C determines the number of the plurality of divided areas IM11, IM12 based on the estimation result of the target point cloud error estimation unit 3H.

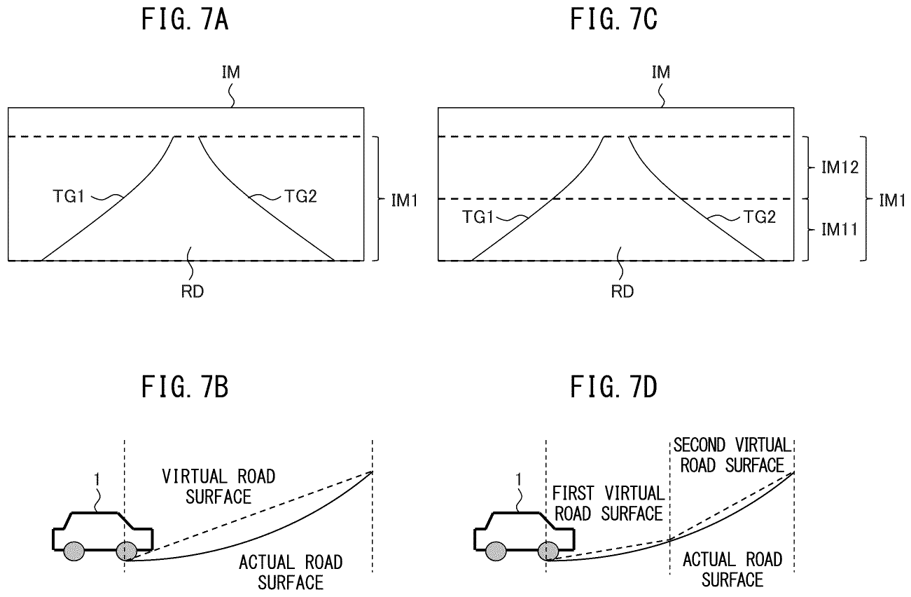

FIG. 7A to FIG. 7D are views for explaining differences between an actual road surface and a virtual road surface when a longitudinal gradient change amount of the road RD on which the host vehicle 1 travels is large. In detail, FIG. 7A shows an example in which the area IM1 is not divided by the area division 3C, FIG. 7B shows the difference between the actual road surface and the virtual road surface in the example in which the area IM1 is not divided by the area division 3C, FIG. 7C shows an example in which the area IM1 is divided into the divided areas IM11, IM12 by the area division unit 3C, and FIG. 7D shows the difference between the actual road surface and the virtual road surface of the divided area IM11 (first virtual road surface) and the difference between the actual road surface and the virtual road surface of the divided area IM12 (second virtual road surface) in the example in which the area IM1 is divided into the divided areas IM11, IM12 by the area division unit 3C.

As shown in FIG. 7A and FIG. 7B, when the area IM1 is not divided although the longitudinal gradient change amount of the road RD on which the host vehicle 1 travels is large, the difference between the actual road surface and the virtual road surface is large.

As shown in FIG. 7C and FIG. 7D, when the longitudinal gradient change amount of the road RD on which the host vehicle 1 travels is large, the difference between the virtual road surface (first virtual road surface, second virtual road surface) and the actual road surface can be made smaller than the example shown in FIG. 7A and FIG. 7B, by dividing the area IM1 into the plurality of divided areas IM11, IM12.

Therefore, as shown in FIG. 2A, when the longitudinal gradient change amount of the road RD on which the host vehicle 1 travels acquired by the longitudinal gradient change amount acquisition unit 3G is large, the area division unit 3C generates the plurality of divided area IM11, IM12 by dividing the area IM1 including the point clouds TG11, TG21 in a longitudinal direction of FIG. 2A.

On the other hand, as shown in FIG. 2B, when the area corresponding to the lane in which the host vehicle 1 travels and the area corresponding to an adjacent lane which is adjacent to the lane in which the host vehicle 1 travels are included in the image IM captured by the camera 11A (for example, when the longitudinal gradient change amount of the lane in which the host vehicle 1 travels and the longitudinal gradient change amount of the adjacent lane are different), the area division unit 3C divides the area IM1 including the point clouds TG11 to TG41 into the divided area IM11 corresponding to the lane in which the host vehicle 1 travels and the divided area IM12 corresponding to the adjacent lane. Furthermore, the vanishing point calculation unit 3D calculates the vanishing point FOE1 of the targets TG1, TG2 of the divided area IM11 based on the point clouds TG11, TG21 included in the divided area IM11 and calculates the vanishing point FOE2 of the targets TG3, TG4 of the divided area IM12 based on the point clouds TG31, TG41 included in the divided area IM12.

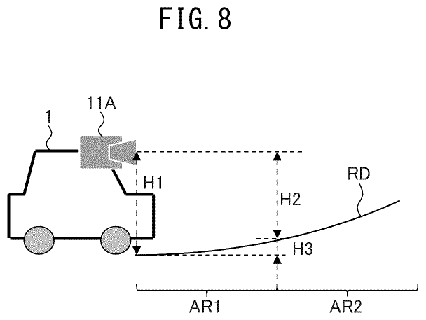

In the example shown in FIG. 1, the height estimation unit 3I estimates the height H3 (see FIG. 8) in the vehicle coordinate system of the road RD (see FIG. 3A to FIG. 3D and FIG. 8) on which the host vehicle 1 travels.

FIG. 8 is a view for explaining the height H3 in the vehicle coordinate system of the road RD on which the host vehicle 1 travels, and the like.

In the example shown in FIG. 3A to FIG. 3D and FIG. 8, the area division unit 3C generates the divided area IM12 and the divided area IM11 by vertically dividing the area IM1 including the point clouds TG11, TG21. The divided area IM12 and the divided area IM11 include the point cloud TG11 showing the line shaped target TG1 (left partition line) located on the left side of the host vehicle 1 and the point cloud TG21 showing the line shaped target TG2 (right partition line) located on the right side of the host vehicle 1.

The vanishing point calculation unit 3D calculates the intersection point of the line shaped target TG1 located on the left side of the host vehicle 1 included in the divided area IM12 and the line shaped target TG2 located on the right side of the host vehicle 1 included in the divided area IM12 as the vanishing point FOE2 of the targets TG1, TG2, based on the point cloud TG11 showing the line shaped target TG1 located on the left side of the host vehicle 1 included in the divided area IM12 and the point cloud TG21 showing the line shaped target TG2 located on the right side of the host vehicle 1. Further, the vanishing point calculation unit 3D calculates the intersection point of the line shaped target TG1 located on the left side of the host vehicle 1 included in the divided area IM11 and the line shaped target TG2 located on the right side of the host vehicle 1 included in the divided area IM11 as the vanishing point FOE1 of the targets TG1, TG2, based on the point cloud TG11 showing the line shaped target TG1 located on the left side of the host vehicle 1 included in the divided area IM11 and the point cloud TG21 showing the line shaped target TG2 located on the right side of the host vehicle 1 included in the divided area IM11.

In addition, the height estimation unit 3I estimates the height H3 in the vehicle coordinate system of the road RD on which the host vehicle 1 travels on a boundary between the divided area IM11 and the divided area IM12 by using equations (1) and (2) below, so that the position in the vehicle coordinate system of the line shaped target TG1 located on the left side of the vehicle 1 on the boundary between the divided area IM11 and the divided area IM12 calculated by using the intersection point (vanishing point FOE2) of the line shaped targets TG1, TG2 included in the divided area IM12 and the position in the vehicle coordinate system of the line shaped target TG1 located on the left side of the vehicle 1 on the boundary between the divided area IM11 and the divided area IM12 calculated by using the intersection point (vanishing point FOE1) of the line shaped targets TG1, TG2 included in the divided area IM11 match, and the position in the vehicle coordinate system of the line shaped target TG2 located on the right side of the vehicle 1 on the boundary between the divided area IM11 and the divided area IM12 calculated by using the intersection point (vanishing point FOE2) of the line shaped targets TG1, TG2 included in the divided area IM12 and the position in the vehicle coordinate system of the line shaped target TG2 located on the right side of the vehicle 1 on the boundary between the divided area IM11 and the divided area IM12 calculated by using the intersection point (vanishing point FOE1) of the line shaped targets TG1, TG2 included in the divided area IM11 match.

$$Z 1 = fy \times H 1 / ( v - foev 1 ) \qquad ( 1 )$$

In the equation (1), Z1 indicates the distance from the camera 11A to a point in the area AR1, fy indicates the focal length/pixel height (pixel vertical width) [px] of the camera 11A, H1 (see FIG. 8) indicates the height of the camera 11A obtained by calibration, v indicates the v coordinate (longitudinal coordinate) in the image IM of the point in the area AR1, and foev1 indicates the v coordinate (longitudinal coordinate) of the vanishing point FOE1 calculated by using the point clouds TG11, TG21 in the divided area IM11.

$$Z 2 = fy \times H 2 / ( v - foev 2 ) \qquad ( 2 )$$

In the equation (2), Z2 indicates the distance from the camera 11A to a point in the area AR2, fy indicates the focal length/pixel height (pixel vertical width) [px] of the camera 11A, H2 (see FIG. 8) indicates the height of the camera 11A from the road surface on the boundary between the divided area IM12 (area AR2) and the divided area IM11 (area AR1), v indicates the v coordinate (longitudinal coordinate) in the image IM of the point in the area AR2, and foev2 indicates the v coordinate (longitudinal coordinate) of the vanishing point FOE2 calculated by using the point clouds TG11, TG21 in the divided area IM12.

On the boundary between the divided area IM12 (area AR2) and the divided area IM11 (area AR1), Z1 is equal to Z2, and the height H2 of the camera 11A from the road surface on the boundary between the divided area IM12 (area AR2) and the divided area IM11 (area AR1) is expressed by equation (3) below.

$$H 2 = H 1 \times ( v 12 - foev 2 ) / ( v 12 - foev 1 ) \qquad ( 3 )$$

In the equation (3), v12 indicates the v coordinate (longitudinal coordinate) in the image IM of the point on the boundary between the divided area IM12 (area AR2) and the divided area IM11 (area AR1).

If the targets TG1, TG2 are, for example, dashed partition lines, there is a possibility that the targets TG1, TG2 do not exist on the boundary between the divided area IM11 and the divided area IM12, and that, for example, the autonomous driving of the host vehicle 1 in which the steering actuator 13A actuated switches to the manual driving of the host vehicle 1 so that the host vehicle 1 does not deviate from thee lane (lane in which the host vehicle 1 is traveling) defined by the targets TG1, TG2 (partition lines), or the like.

Therefore, in the example shown in FIG. 1, the target position estimation unit 3J estimates the position of the targets TG1, TG2 on the boundary between the divided area IM11 and the divided area IM12.

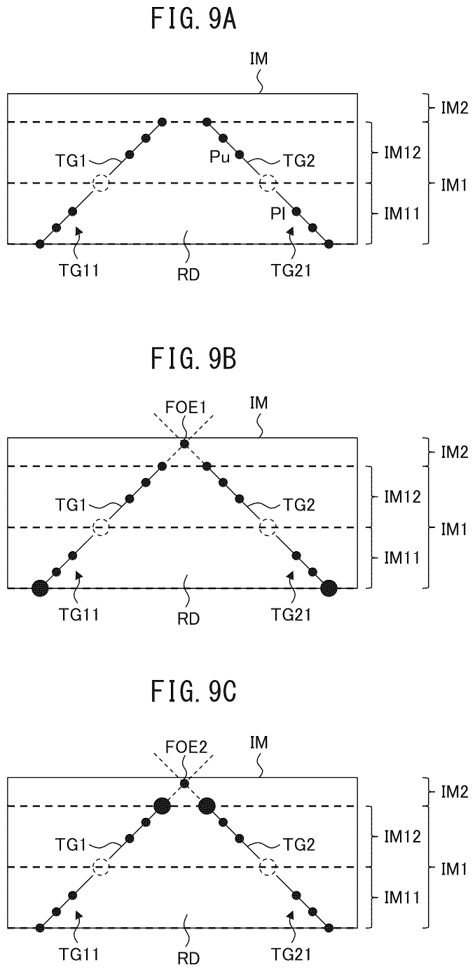

FIG. 9A to FIG. 9C are views for explaining an example of a process performed by the target position estimation unit 3J, and the like. Specifically, FIG. 9A shows the process in which the target position estimation unit 3J estimates positions of the targets TG1, TG2 on the boundary between the divided area IM11 and the divided area IM12, and FIG. 9B shows the process in which the vanishing point calculation unit 3D calculates the vanishing point FOE1 of the targets TG1, TG2 included in the divided area IM11 by using the positions of the targets TG1, TG2 on the boundary between the divided area IM11 and the divided area IM12 estimated by the target position estimation unit 3J, and FIG. 9C shows the process in which the vanishing point calculation unit 3D calculates the vanishing point FOE2 of the targets TG1, TG2 included in the divided area IM12 by using the positions of the targets TG1, TG2 on the boundary between the divided area IM11 and the divided area IM12 estimated by the target position estimation unit 3J.

As shown in FIG. 9A, when the point clouds TG11, TG21 showing the targets TG1, TG2 do not exist on the boundary between the divided area IM11 and the divided area IM12, the target position estimation unit 3J estimates the positions (positions shown by dotted circles in FIG. 9A) of the targets TG1, TG2 on the boundary between the divided area IM11 and the divided area IM12, by using the point clouds TG11, TG21 showing the targets TG1, TG2 included in the divided area IM12 and/or the divided area IM11.

For example, the target position estimation unit 3J uses a straight line model which uses, for example, a point Pl (ul, vl) on the target TG2 in the divided area IM11 which is located nearest to the boundary between the divided area IM11 and the divided area IM12 and a point Pu (uu, vu) on the target TG2 in the divided area IM12 which is located nearest to the boundary between the divided area IM11 and the divided area IM12, in order to estimate the position of the target TG2 on the boundary between the divided area IM11 and the divided area IM12.

A line passing through the point Pl (ul, vl) on the target TG2 in the divided area IM11 and the point Pu (uu, vu) on the target TG2 in the divided area IM12 is expressed by the following equations.

$$u = ( v - vu ) / α + uu$$

$$α = ( vl - vu ) / ( ul - uu )$$

A horizontal position ub of the target TG2 on the border between the divided area IM11 and the divided area IM12 is expressed by the following equation.

$$ub = ( vb - vu ) / α + uu$$

As shown in FIG. 9B, the vanishing point calculation unit 3D calculates the vanishing point FOE2 of the targets TG1, TG2 included in the divided area IM12 and the vanishing point FOE1 of the targets TG1, TG2 included in the divided area IM11 by using the positions of the targets TG1, TG2 on the boundary between the divided area IM11 and the divided area IM12 estimated by the target position estimation unit 3J.

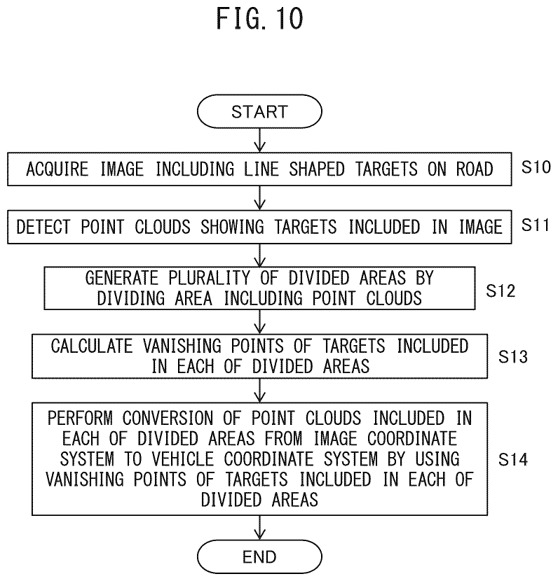

FIG. 10 is a flowchart for explaining an example of the process performed by the processor 123 of the target recognition device 12 of the first embodiment.

In the example shown in FIG. 10, at step S10, the acquisition unit 3A acquires the image IM including the line shaped targets TG1 to TG4 on the road RD, RD1 on which the host vehicle 1 travels or the like captured by the camera 11A.

At step S11, the target point cloud detection unit 3B detects the point clouds TG11 to TG41 showing the targets TG1 to TG4 included in the image IM acquired at step S10.

At step S12, the area division unit 3C generates the plurality of divided areas IM11, IM12 by dividing the area IM1 which includes the point clouds TG11 to TG41 detected at step S11 and is included in the image IM.

At step S13, the vanishing point calculation unit 3D calculates the vanishing points FOE1, FOE2 of the targets TG1 to TG4 included in each of the plurality of divided areas IM11, IM12 based on the point clouds TG11 to TG41 included in each of the plurality of divided areas IM11, IM12.

At step S14, the coordinate conversion unit 3E performs the conversion of the point clouds TG11 to TG41 included in each of the plurality of divided areas IM11, IM12 from the image coordinate system to the vehicle coordinate system, by using the vanishing points FOE1, FOE2 of the targets TG1 to TG4 included in each of the plurality of divided areas IM11, IM12 calculated at step S13.

### Second Embodiment

The host vehicle 1 to which the target recognition device 12 of a second embodiment is applied is configured similarly to the host vehicle 1 to which the target recognition device 12 of the first embodiment described above is applied, except that it will be described later.

In the host vehicle 1 to which the target recognition device 12 of the first embodiment is applied as described above, the area division unit 3C generates basically two divided areas IM11, IM12 by dividing the area IM1 which includes the point clouds TG11 to TG41 detected by the target point cloud detection unit 3B and is included in the image IM.

On the other hand, in the host vehicle 1 to which the target recognition device 12 of the second embodiment is applied, the area division unit 3C generates basically the plurality of divided areas other than 2 (e.g. 3 or the like) by dividing the area IM1 which includes the point clouds TG11 to TG41 detected by the target point cloud detection unit 3B and is included in the image IM.

### Third Embodiment

The host vehicle 1 to which the target recognition device 12 of a third embodiment is applied is configured similarly to the host vehicle 1 to which the target recognition device 12 of the first embodiment described above is applied, except that it will be described later.

In the host vehicle 1 to which the target recognition device 12 of the first embodiment is applied as described above, the vanishing point calculation unit 3D calculates the intersection point of the straight line passing through the point cloud TG11 (point cloud TG11 showing the target TG1 located on the left side of the host vehicle 1) included in the divided area IM11 and the straight line passing through the point cloud TG21 (point cloud TG21 showing the target TG2 located on the right side of the host vehicle 1) included in the divided area IM11 as the vanishing point FOE1.

On the other hand, in the host vehicle 1 to which the target recognition device 12 of the third embodiment is applied, the vanishing point calculation unit 3D may calculate the vanishing point of the point cloud TG11 or the vanishing point of the point cloud TG21 based on only one of the point cloud TG11 showing the target TG1 located on the left side of the host vehicle 1 and the point cloud TG21 showing the target TG2 located on the right side of the host vehicle, 1 by using the characteristics in which the perspective lines are gathered on the horizontal line.

As described above, although the embodiments of the target recognition device, the target recognition method, and the non-transitory recording medium of the present disclosure have been described with reference to the drawings, the target recognition device, the target recognition method, and the non-transitory recording medium of the present disclosure are not limited to the embodiments described above, and may be appropriately changed without departing from the scope of the present disclosure. The configuration of each example of the embodiment described above may be appropriately combined. In each example of the above-described embodiment, the process performed in the target recognition device 12 has been described as software process performed by executing the program, but the process performed in the target recognition device 12 may be process performed by hardware. Alternatively, the process performed by the target recognition device 12 may be a combination of both software and hardware. Further, the program (program for realizing the function of the processor 123 of the target recognition device 12) stored in the memory 122 of the target recognition device 12 may be recorded in a computer-readable storage medium (non-transitory recording medium) such as, semiconductor memory, magnetic recording medium, optical recording medium, or the like for providing, distribution or the like.

1. A target recognition device comprising a processor configured to:
acquire an image which includes a line shaped target on a road on which a host vehicle travels, and which is captured by a camera;
detect a point cloud showing the target included in the image;
generate a plurality of divided areas by dividing an area which includes the point cloud and is included in the image;
calculate a vanishing point of the target included in each of the plurality of divided areas based on the point cloud included in each of the plurality of divided areas; and
perform a conversion from an image coordinate system to a vehicle coordinate system,
wherein the processor is configured to perform the conversion of the point cloud included in each of the plurality of divided areas from the image coordinate system to the vehicle coordinate system, by using the vanishing point of the target included in each of the plurality of divided areas.

2. The target recognition device according to claim 1, wherein the processor is configured to estimate a static posture of the camera based on calibration result or traveling learning result,
the processor is configured to perform the conversion of the point cloud included in each of the plurality of divided areas from the image coordinate system to the vehicle coordinate system, by using a horizontal coordinate of the vanishing point on the image which is calculated from the static posture of the camera, and a vertical coordinate of the vanishing point of the target included in each of the plurality of divided areas on the image.

3. The target recognition device according to claim 1, wherein the processor is configured to acquire a longitudinal gradient change amount of the road on which the host vehicle travels,
the processor is configured to determine the number of the plurality of divided areas or division position of the area including the point cloud, based on the longitudinal gradient change amount.

4. A target recognition method comprising:
acquiring an image which includes a line shaped target on a road on which a host vehicle travels, and which is captured by a camera;
detecting a point cloud showing the target included in the image;
generating a plurality of divided areas by dividing an area which includes the point cloud and is included in the image;
calculating a vanishing point of the target included in each of the plurality of divided areas based on the point cloud included in each of the plurality of divided areas; and
performing a conversion from an image coordinate system to a vehicle coordinate system,
wherein the conversion of the point cloud included in each of the plurality of divided areas from the image coordinate system to the vehicle coordinate system is performed by using the vanishing point of the target included in each of the plurality of divided areas.

5. A non-transitory recording medium having recorded thereon a computer program for causing a processor to perform a process comprising:
acquiring an image which includes a line shaped target on a road on which a host vehicle travels, and which is captured by a camera;
detecting a point cloud showing the target included in the image;
generating a plurality of divided areas by dividing an area which includes the point cloud and is included in the image;
calculating a vanishing point of the target included in each of the plurality of divided areas based on the point cloud included in each of the plurality of divided areas; and
performing a conversion from an image coordinate system to a vehicle coordinate system,
wherein the conversion of the point cloud included in each of the plurality of divided areas from the image coordinate system to the vehicle coordinate system is performed by using the vanishing point of the target included in each of the plurality of divided areas.
